(19) United States
(12) Patent Application Publication
(10) Pub. No.: US 2008/0299369 A1
(43) Pub. Date: Dec. 4, 2008

(54) Composite Nanosheet, Method of Producing the Same, and Method for Producing Metal Oxide Nanosheet

(75) Inventors: Motonari Adachi, Hyogo (JP); Keizo Nakagawa, Osaka (JP); Yusuke Murata, Toyama (JP); Kensuke Sagoh, Nara (JP); Yukihiro Nishikawa, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KYOTO UNIVERSITY, Kyoto-shi (JP)

(21) Appl. No.: 11/571,786

(22) PCT Filed: Jul. 1, 2005
(86) PCT No.: PCT/JP2005/012183

§ 371 Date: Aug. 14, 2008

(30) Foreign Application Priority Data
Jul. 9, 2004 (JP) 2004-202533

(51) Int. Cl. B32B 9/00; B32B 5/00; B32B 38/10

(52) U.S. Cl. 428/220; 428/702; 156/344

(57) ABSTRACT

Various metal oxide nanosheets with uniform thickness under mild conditions and in a short time are provided. A mixed solution containing a surfactant such as laurylamine and a metal alkoxide are allowed to flow over water surface to obtain a composite nanosheet. The composite nanosheet comprises a lamella molecular film consisting of a surfactant, and a metal oxide nanosheet formed along the surface of the molecular film. If necessary, the composite nanosheet was separated and then immersed in a solvent in which the surfactant can be dissolved, to separate the metal oxide nanosheet from the molecular film.

### TECHNICAL FIELD

The present invention relates to a metal oxide nanosheet, a composite nanosheet consisting of the metal oxide nanosheet and a lamella molecular film of a surfactant, and a method of producing them.

### BACKGROUND ART

Materials of nanosize, e.g., a ceramic nanosheet, may exhibit interesting properties which cannot be expected of a bulk phase. Thus, various technologies have been investigated on the method of production thereof. As a conventional method of producing a ceramic nanosheet, a sol-gel method, an electrolytic oxidation method, and a CVD method are known.

Further, in recent years, methods of producing a ceramic nanosheet by delaminating layered compounds such as layered manganese oxide in Patent Literature 1, layered titanate salt in Non-Patent Literature 1, layered perovskite in Non-Patent Literature 2, layered niobate salt in Non-Patent Literature 3, and the like have also been proposed. Starting materials of these layered compounds require to be fired at an elevated temperature of 800 to 1300° C. for a long time of 10 to 40 hours for acid treatment in a post-process.

### [Patent Literature 1] Japanese Unexamined Patent Publication No. 2003-335522

[Non-Patent Literature 1] Sasaki, T., M. Watanabe, H. Hashizume, H. Yamada, and H. Nakazawa “Macromolecule-like aspects for a colloidal suspension of an exfoliated titanate. Pairwise association of nanosheets and dynamic reassembling process initiated from it” Journal of The American Chemical Society, 125, 3568-3575 (2003)
[Non-Patent Literature 2] Schaak, R. E. and T. E. Mallouk “Prying apart Ruddlesden-Popper phses: Exfoliation into sheets and nanotubes for assembly of perovskite thin films” Chemistry of Materials, 12, 3427-3434 (2000b)

### [Non-Patent Literature 3] Saupe, G., C. C. Waraksa, H.-N. Kim, Y. J. Han, D. M. Kaschak, D. M. Skinnerand T. E. Mallouk Chemistry of Materials, 12, 1556-1562 (2000)

### DISCLOSURE OF THE INVENTION

However, it is difficult to make a film thickness uniform in the sol-gel method or the electrolytic oxidation method. The CVD method is not productive since it requires expensive CVD equipment.

On the other hand, the methods described in Patent Literature 1 and Non-Patent Literature 1 to 3 need the process step of firing at an elevated temperature for a long time as described above in order to obtain the starting materials. Accordingly, in these methods, it takes much cost and in addition it is impossible to combine the ceramic nanosheet with another materials which can exist only at low temperature, for example, enzymes or organic compounds, from the stage of a raw material. In addition, a nanosheet which can be produced by these methods is limited to one capable of forming a layered structure. Furthermore, an operation of eliminating a remover such as an amine is also required.

Thus, it is an object of the present invention to provide various metal oxide nanosheets having a uniform film thickness which can be obtained under mild conditions and in a short time. In addition, it is another object of the present invention to provide a composite nanosheet of a surfactant and a metal oxide nanosheet as a precursor of such a metal oxide nanosheet.

In order to achieve the above-mentioned objects a composite nanosheet of the present invention is characterized by comprising a molecular film consisting of a surfactant and having a lamella structure, and a metal oxide nanosheet formed along the surface of this molecular film.

In this composite nanosheet, since the metal oxide nanosheet having a nanosize or a thickness of 10 nm or less is formed along the surface of the molecular film having a lamella structure, it is possible to preserve the composite nanosheet as-is to maintain a uniform film thickness of a nanosize thereof and to separate and abstract the metal oxide nanosheet when required.

A proper method of abstracting the metal oxide nanosheet from the composite nanosheet is characterized in that the metal oxide nanosheet is separated from the above-mentioned composite nanosheet by drying the composite nanosheet and then immersing it in a solvent in which the above-mentioned surfactant can be dissolved.

According to this method, if using a solvent such as alcohol, in which the surfactant can be dissolved, it is possible to easily separate the metal oxide nanosheet from the molecular film to abstract it even if not using particularly special one. And, since the solvent is an ordinary solvent such as alcohol, it is easy to purify the resultant metal oxide nanosheet.

The above-mentioned composite nanosheet can be produced by bringing a mixed solution containing a surfactant and a metal alkoxide into contact with water.

The surfactant may be one which forms a lamella structure and is not particularly limited. A preferred surfactant is a cationic surfactant and a nonionic surfactant. A particularly preferred surfactant is a cationic surfactant such as amines or the like. Though the production mechanism of the composite nanosheet is uncertain, the following mechanism is conceivable. When a surfactant and a metal alkoxide are mixed, the pre-hydrolysis metal alkoxide 1 is surrounded by hydrophobic groups 2a of the surfactant 2 as shown in FIG. 1 since it has a hydrophobic property. When this mixed solution is gently brought into contact with water 3, the surfactant 2 forms a lamella structure from its nature, and the metal alkoxide having moved (arrow A indicates the direction of movement) to an interface i between liquid (organic phase) and liquid (water phase) reacts with water 3 while water 3 having permeated (arrow B indicates the direction of permeation) between hydrophilic groups 2b reacts with the metal alkoxide 1, and the metal alkoxide is hydrolyzed. Consequently, a metal oxide nanosheet 4 is formed along the lamella molecular film of the surfactant.

By this method, the starting material of the metal oxide may be a metal alkoxide, and the species of metal and the species of an alkoxy group are not limited. Therefore, a variety of metal oxide nanosheets can be obtained. Besides, the time required to hydrolyze the metal alkoxide is, though it varies in accordance with the species of the metal alkoxide, generally an instance or within one hour at longest, and in addition the reaction temperature may be a mild one of 100° C. or lower. Further, the film thickness of the metal oxide nanosheet to be obtained is uniform since it is regulated by the lamella molecular film.

As described above, since in the present invention, a metal oxide nanosheet is produced by making use of hydrolysis of metal alkoxide and a given lamella molecular film, it is possible to obtain a variety of metal oxide nanosheets at low cost under mild conditions and in a short time.

### BRIEF DESCRIPTION OF THE DRAWINGS

FIG. 1 is a view showing the behavior of a raw material in a method of producing a composite nanosheet of the present invention.

FIG. 2 is a view of small angle X-ray scattering (SAXS) patterns at an interface between liquid (organic phase) and liquid (water phase) after lapses of times since flowing laurylamine (LA) over the surface of water.

FIG. 3 is a view of a SAXS pattern of LAS which was drawn out from a liquid-liquid interface after a lapse of 120 seconds since flowing laurylamine (LA) over the surface of water and dried.

FIG. 4 is a view of SAXS patterns at a liquid-liquid interface after lapses of 25 seconds and 125 seconds since flowing a mixed solution (a mixing ratio is 0.2) of germanium alkoxide and LA over the surface of water.

FIG. 5 is a view of patterns by a logarithmic plot of the above-mentioned SAXS intensity after lapses of times since flowing the mixed solution.

FIG. 6 is a TEM image of a product at a liquid-liquid interface after a lapse of 3 minutes since flowing the above mixed solution over the surface of water.

FIG. 7 is a SEM image of a product at a liquid-liquid interface after a lapse of 5 minutes since flowing the above mixed solution over the surface of water.

FIG. 8 is an electron diffraction pattern of a product at a liquid-liquid interface of the above mixed solution.

FIG. 9 is an HRTEM image of a product at a liquid-liquid interface of the above mixed solution.

FIG. 10 is a result of comparing the respective patterns of FIG. 5 to a fitting function which is formed by mixing a Gaussian function and a Lorentz function.

FIG. 11 is a TEM image of a layered GeO2 nanosheet sandwiched between LA molecular films, the TEM image being taken obliquely relative to a sheet face.

FIG. 12 is a view of patterns by a logarithmic plot of SAXS intensity at a liquid-liquid interface after lapses of times since flowing a mixed solution (a mixing ratio is 0.03) of germanium alkoxide and LA over the surface of water.

FIG. 13 is a view of patterns by a logarithmic plot of SAXS intensity at a liquid-liquid interface after lapses of times since flowing a mixed solution (a mixing ratio is 0.1) of TEOS and LA over the surface of water.

FIG. 14 is a TEM image of a product at a liquid-liquid interface after a lapse of 30 minutes since flowing the above mixed solution over the surface of water.

FIG. 15 is a TEM image of a product at a liquid-liquid interface after a lapse of 30 minutes since flowing the mixed solution (a mixing ratio is 0.5) of TEOS and LA over the surface of water.

### DESCRIPTION OF SYMBOLS

1 metal alkoxide
2 surfactant
2a hydrophobic group
2b hydrophilic group
3 water
4 metal oxide nanosheet
i interface between liquid of organic phase and liquid of water phase

### BEST MODE FOR CARRYING OUT THE INVENTION

In accordance with the present invention, for example, a germanium dioxide nanosheet forming a nearly square having a side of 1000 nm or less in a plan view is obtained as a metal oxide nanosheet in the above-mentioned composite nanosheet. Further, it is possible that the total thickness of the surfactant molecular film and the metal oxide nanosheet, but it depends on the initial thickness of the molecular film, is 5 nm or less. Therefore, a nanosheet consisting of germanium dioxide would also be usable as a catalyst in a production or decomposition process of PET resin.

In the method of producing the composite nanosheet, the contact of the above-mentioned mixed solution with water is preferably made by allowing the mixed solution to flow over the surface of water. The reason for this is that water permeates into hydrophilic groups of a lamella molecular film formed on the surface of water and the metal alkoxide is hydrolyzed along the surface of the molecular film. A preferred range of a mixing ratio of the metal alkoxide to the surfactant varies depending on the chemical species of each compound, but when the above surfactant is laurylamine and the metal alkoxide is Ge(OR)₄, wherein R is an alkyl group having 1 to 4 carbon atoms, preferably an ethoxy group, the molar concentration ratio [Ge(OR)₄]/[laurylamine] is preferably 0.01 or more and 0.5 or less and particularly preferably 0.03 or more and 0.2 or less. When the metal alkoxide is Si(OR)₄, wherein R is an alkyl group having 1 to 4 carbon atoms, preferably an ethoxy group, the molar concentration ratio [Si(OR)₄]/[laurylamine] is preferably 0.01 or more and 0.5 or less. The reason for this is that when the amount of the metal alkoxide is too large or too small with respect to the surfactant, it is hard to form a sheet.

### EXAMPLES

### Example 1

An example of producing a germanium dioxide nanosheet in accordance with the present invention will be described.

Laurylamine, CH₃(CH₂)₁₁NH₂, of a purity not less than 95% (produced by Tokyo Chemical Industry Co., Ltd., hereinafter, abbreviated as LA), acetylacetone (produced by NACALAI TESQUE, INC.), and germanium ethoxide, Ge(OEt)₄, of a purity not less than 99.9% (produced by Wako Pure Chemical Industries, Ltd.) were prepared.

Acetylacetone and Ge(OEt)₄ were then mixed in a molar ratio of 1:1, and this mixture was further mixed with LA in such a way that [Ge(OEt)₄]/[LA]=0.2 (molar ratio). By flowing this mixed solution gently over the surface of water, a composite nanosheet consisting of a germanium dioxide nanosheet and a LA molecular film was obtained.

Separately, a LA molecular film was obtained as a reference by flowing only LA over the surface of water similarly.

Methods of analyses and identifications are as follows.

A small angle X-ray scattering (SAXS) was measured by a beam line BL45XU of Spring-8 of Japan Synchrotron Radiation Research Institute (JASRI). In addition, a cell having a size of 60 mm in height, 3 mm in depth and 5 mm in width was filled with one-half full of pure water. The location of X-ray beam irradiation was adjusted so as to be at the surface of water. The beam intensity was 10¹³ photon/sec and the beam cross section was 200 μm or less both in width and height. A LA solution or a mixed solution of LA and alkoxide was then allowed to flow over the surface of water as described above, SAXS intensity was measured every second with a CCD detector since right after the initiation of a reaction,

JEM-200CX manufactured by JEOL Ltd. was used as a transmission electron microscope (TEM) and the acceleration voltage was set at 200 V. JSM-5510 manufactured by JEOL Ltd. was used as a scanning electron microscope (SEM), and measurement was carried out at 130 mA and an acceleration voltage of 5 to 20 kV. In addition, a sample solution was prepared by stirring a dried powder of a composite nanosheet to disperse it in 2-propanol, and this dispersion was poured on the TEM grid and observed. Further, a crystal structure of the germanium dioxide nanosheet in a TEM image was analyzed by selected area electron diffraction (SAED). The calibration of these measurements was carried out using a gold vapor deposition film. X-ray powder diffraction was performed under the conditions of CuKα, 35 kV and 20 mA using RAD II-C manufactured by Rigaku Corporation.

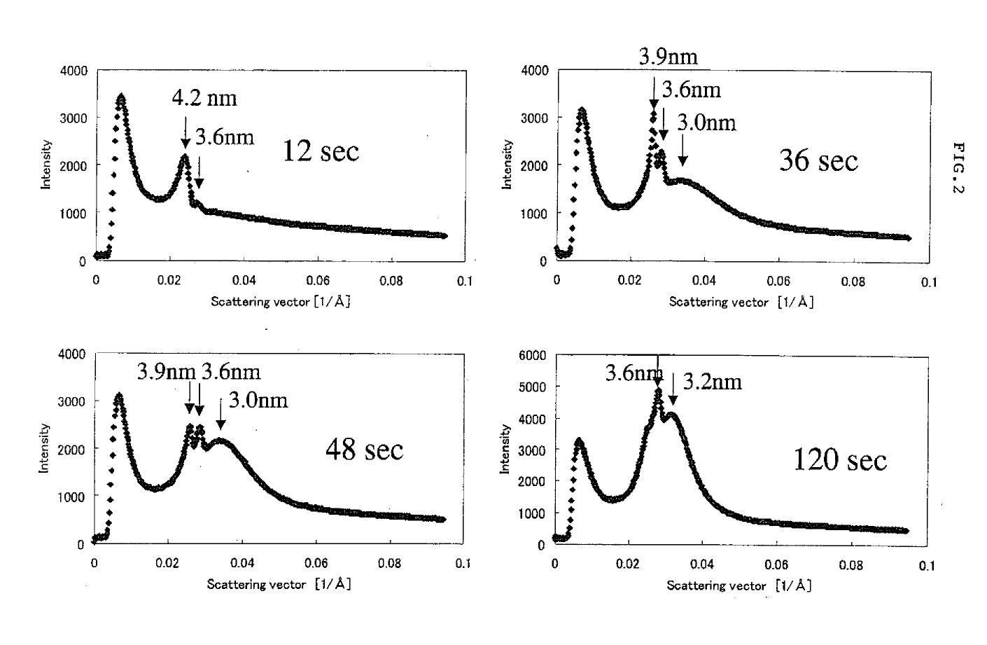

Next, the results of analyses and identifications are shown together with drawing. FIG. 2 indicates measured data (the horizontal axis is a scattering vector) of SAXS intensity obtained by irradiating synchrotron radiation to the LA molecular film prepared as a reference. As is shown in FIG. 2, there were observed a peak at a position where a periodic distance of an electron density d=4.2 nm in 12 seconds, and sharp peaks at positions where periodic distances d=3.9 nm and 3.6 nm, respectively, and a broad peak at a position where a periodic distance d=3.0 nm in 36 seconds after flowing laurylamine (LA) over the surface of water. The sharp peak thereof indicates that the obtained layers have much the same periodic distance, that is, the obtained layers have lamella structures aligned. On the other hand, the broad peak indicates that the obtained layers have lamella structures deforming a little. The peak at a periodic distance d of 3.9 nm was reduced in height with the passage of time, and in the end, it was vanished and simultaneously the peak at a periodic distance d of 3.6 nm was increased in height.

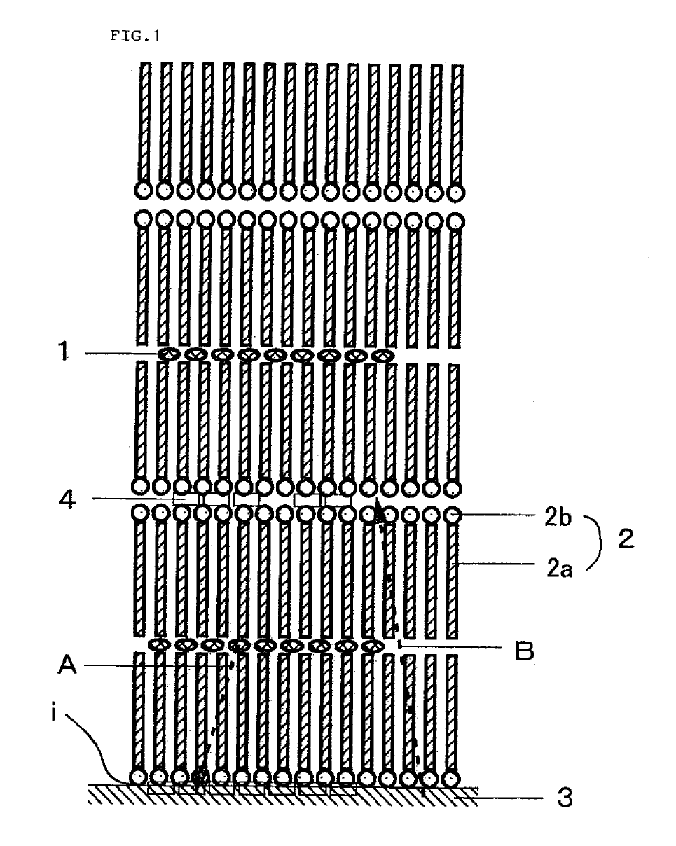

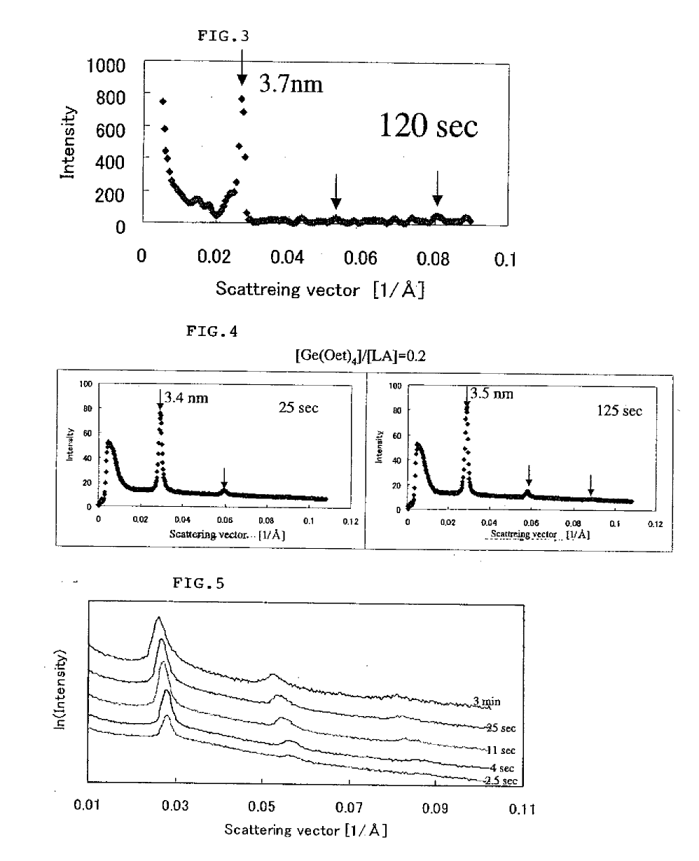

FIG. 3 is a view of SAXS data of one obtained by drying a sample at 40° C. after a lapse of 120 seconds since flowing laurylamine (LA) over the surface of water and pulverizing it. A sharp peak at a periodic distance d of 3.7 nm, and a secondary and a tertiary peaks indicated by the arrows show evidently that the periodic distance d become 3.7 nm in the dried lamella layer. From the results of FIGS. 2 and 3, it is recognized that the lamella layer of a periodic distance d of 4.2 nm, which was observed at an initial stage after flowing LA, contained much water. Further, it is recognized that with the passage of time, lamella layers grow and the peak of an upper lamella layer which is far from the interface (position denoted by a symbol i in FIG. 1) between liquid (organic phase) and liquid (water phase) and does not contain water so much appears prominently.

FIG. 4 is a view showing SAXS data of a lamella structure obtained by flowing a mixed solution containing germanium alkoxide over the surface of water, and the views on the left side and right side exhibit the states after lapses of 25 seconds and 125 seconds, respectively, since flowing the mixed solution. A sharp peak at a periodic distance d of 3.4 nm or 3.5 nm, a secondary peak and a tertiary peak were observed even after a lapse of 125 seconds. If the SAXS data after a lapse of 125 seconds of FIG. 4 is compared with that after a lapse of 120 seconds of FIG. 2, it is evident that the addition of alkoxide forms lamella structures aligned more stably because it is shown from these Figs. that the peak of FIG. 4 is more sharp than that of FIG. 2 and therefore the distances between lamella layers of FIG. 4 are more uniform than those of FIG. 2.

FIG. 5 is a view by a logarithmic plot of the SAXS intensity in which a lapse of time since flowing the above mixed solution over the surface of water is a parameter. It is recognized that a periodic distance d is almost constant regardless of the passage of time and become 3.7 nm which is identical to the total thickness of a LA molecular film and a germanium dioxide nanosheet

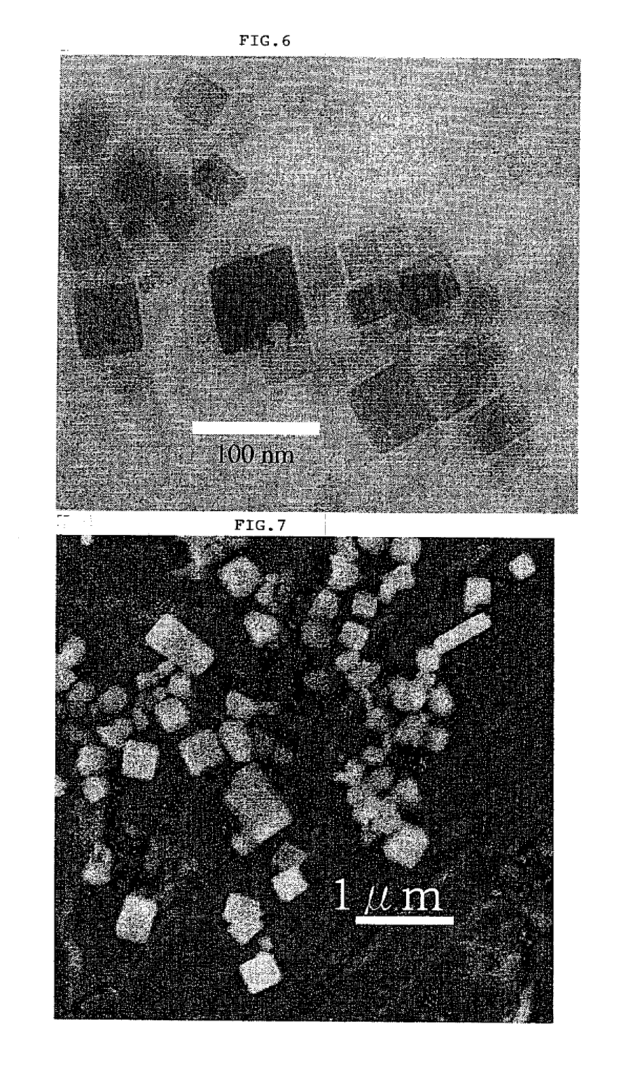

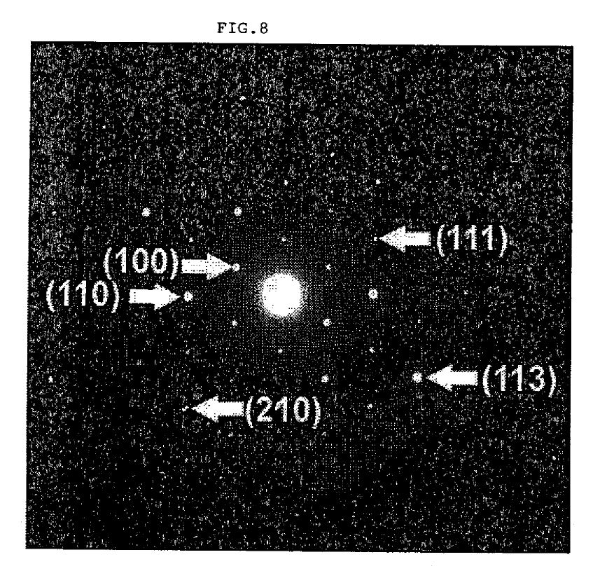

FIG. 6 is a TEM image in taking a photo of a reaction product at an interface (position denoted by a symbol i in FIG. 1) between liquid (organic phase) and liquid (water phase) after a lapse of 3 minutes since the above mixed solution comes into contact with water. Many square nanosheets, which are identified as germanium dioxide, having a side of about 30 to 100 nm are found. FIG. 7 is a SEM image in taking a photo of a reaction product after a lapse of 5 minutes similarly. Many cubes having a side of about 300 to 700 nm are found. It is recognized from FIGS. 6 and 7 that the cubes in FIG. 7 is a laminate of a GeO₂ nanosheet sandwiched between LA lamella molecular films. Further, the reason why unevenness in color occurs among some sheets in FIG. 6 is presumably that a laminate of many sheets is imaged in a dense color and a laminate of one sheet or a small number of sheets is imaged in a light color.

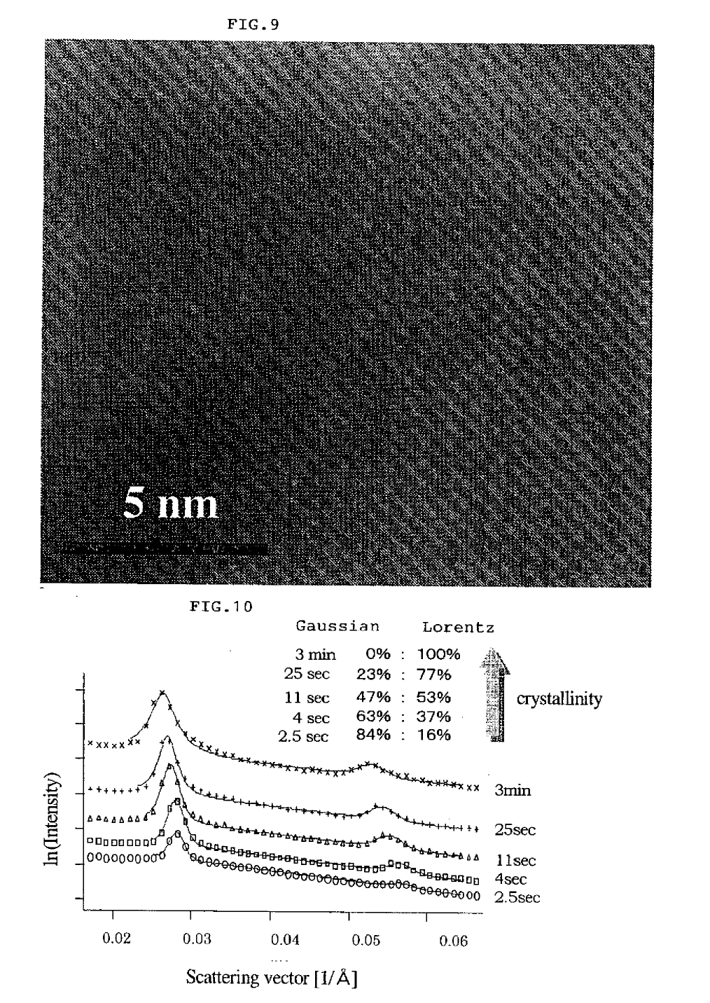

Next, a sample after a lapse of 3 minutes since the above mixed solution comes into contact with water was cleaned with alcohol to remove the surfactant and was dried at 80° C. An electron diffraction pattern (SAED) of the resulting GeO₂ nanosheet is shown in FIG. 8. It is recognized that this nanosheet has highly excellent crystallinity since many spots corresponding to a crystal lattice appear clearly. FIG. 9 is an HRTEM image of this GeO₂ nanosheet. From FIG. 9, it is also possible to verify that the nanosheet has high crystallinity because a lattice image is clearly reflected in FIG. 9.

FIG. 10 is a result of comparing the SAXS data of FIG. 5 to a fitting function which is composed of a combination of a Gaussian function and a Lorentz function. That is, since the Gaussian function fits for the case where a material is amorphous and the Lorentz function fits for the case where a material has high crystallinity, letting a fitting function=α× Gaussian function+β×Lorentz function (wherein α+β=1), the crystallinity is assessed from the values of α and β of the fitting function applied. In FIG. 10, the graphs made in solid lines represents the SAXS data transcribed from FIG. 5 and the dots denoted by the various symbols represents the values calculated based on the fitting function. As is seen in FIG. 10, α was 0.84 and β was 0.16 after a lapse of 2.5 seconds since the mixed solution was brought into contact with water, that is, the Gaussian distribution was 84% and the Lorentz distribution was 16%, and β became 1 after a lapse of 3 minutes since the mixed solution was brought into contact with water, that is, the Lorentz distribution became 100%, and therefore it is found that the crystallinity was enhanced.

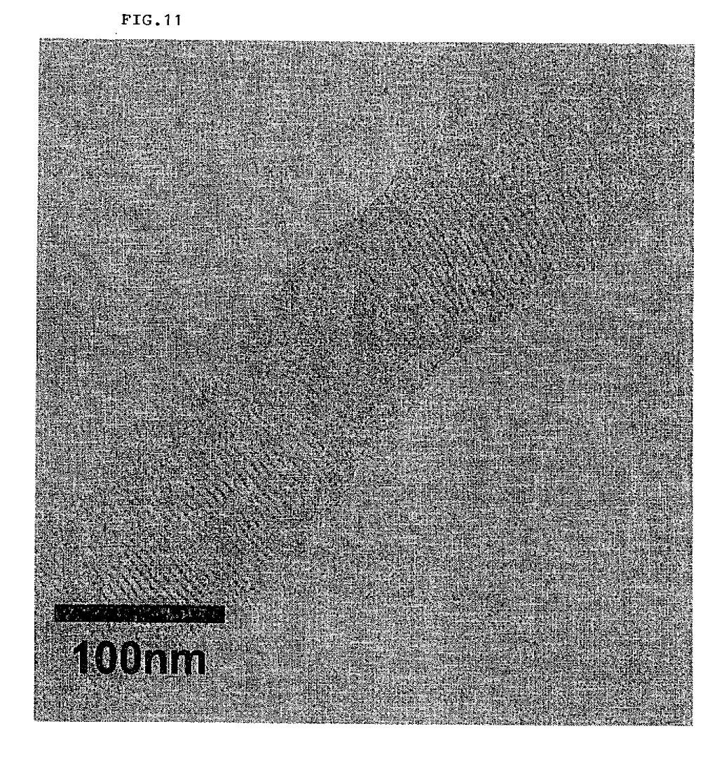

FIG. 11 is a TEM image of a layered GeO2 nanosheet sandwiched between LA molecular films, the TEM image being taken obliquely relative to a sheet face. In FIG. 11, black portions forming a multilayer indicate GeO₂ and white portions between the black portions indicate LA molecular films. From this image, it is recognized that each GeO₂ sheet has a thickness of several nanometers.

Accordingly, it is evident from this Example that a laminate of a GeO₂ nanosheet having highly excellent crystallinity is obtained in a short time of several minutes.

### Example 2

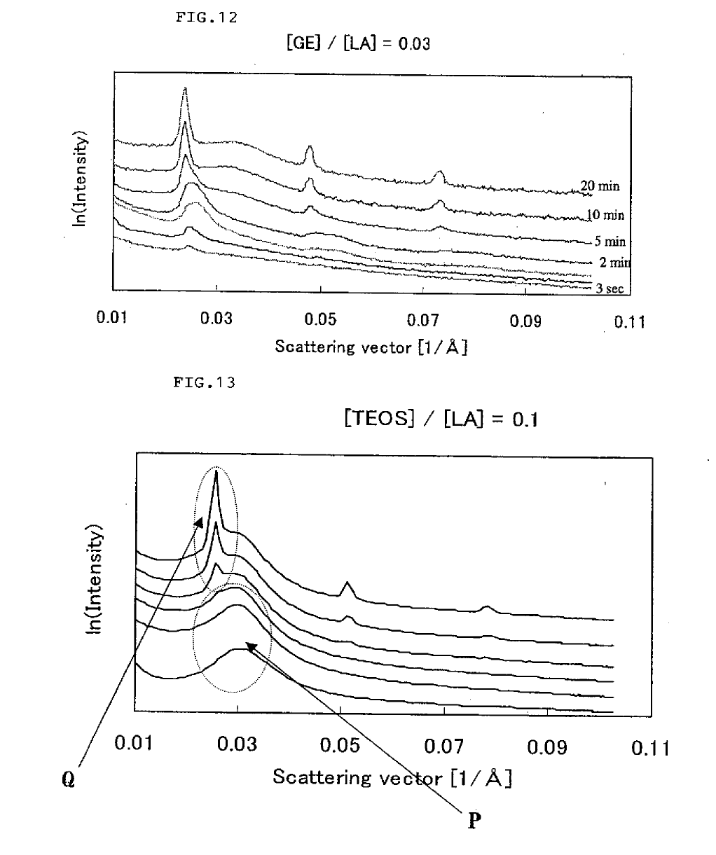

A mixed solution was allowed to flow over the surface of water under the same conditions as in Example 1 except for preparing the mixed solution by mixing a tetraethoxygermanium solution and LA in such a way that [Ge(OEt)₄]/[LA]=0.03 (molar ratio). The SAXS pattern was then measured after each elapsed time as with Example 1. The results of measurement are shown in FIG. 12. As is seen in FIG. 12, the peak after a lapse of 3 seconds is lower and broader than the peak after a lapse of 2.5 seconds in FIG. 5 and the peak after a lapse of 5 minutes is similar to the peak after a lapse of 3 minutes in FIG. 5, and therefore it is recognized that the reaction is slower than that in Example 1. However, the fact that a laminate of a GeO₂ nanosheet having highly excellent crystallinity is obtained in a short time of several minutes is similar to Example 1.

### Example 3

This example is an example of producing a SiO₂ nanosheet. Tetraethoxysilane, Si(OEt)₄ (hereinafter, abbreviated as “TEOS”), of 99.5% in purity (produce by KANTO CHEMICAL CO., INC.) was used as a starting material in place of Ge(OEt)₄ of Example 1. Further, TEOS and LA were mixed in various ratios of [TEOS]/[LA]=0.01, 0.03, 0.1, 0.2, 0.5, 1 and 4 without diluting the solution with acetylacetone to prepare mixed solutions.

The mixed solution was allowed to flow over the surface of water and the SAXS pattern was measured after each elapsed time as with Example 1. As a result of this, a sharp peak identified as amorphous SiO₂ nanosheet was observed with the passage of time in the range of a concentration ratio [TEOS]/[LA] of 0.01 to 0.5. An example of the SAXS pattern in the case where [TEOS]/[LA]=0.1 is shown in FIG. 13. Of six graphs in FIG. 13, the lowermost graph exhibits a pattern after a lapse of 6 seconds since flowing the mixed solution over the surface of water, upper graphs thereof exhibit patterns after lapses of 72 seconds, 5 minutes, 9 minutes, 13 minutes, and 20 minutes in order. When the lapse of time is 5 minutes or less, it is recognized that a lamella molecular film has been not yet completed because the peak is broad like a portion of P, but when the lapse of time is 9 minutes or more, it is assumed that a lamella molecular film has been made and a SiO₂ nanosheet is formed between hydrophilic groups of the lamella molecular film because the peak becomes sharp like a portion of Q.

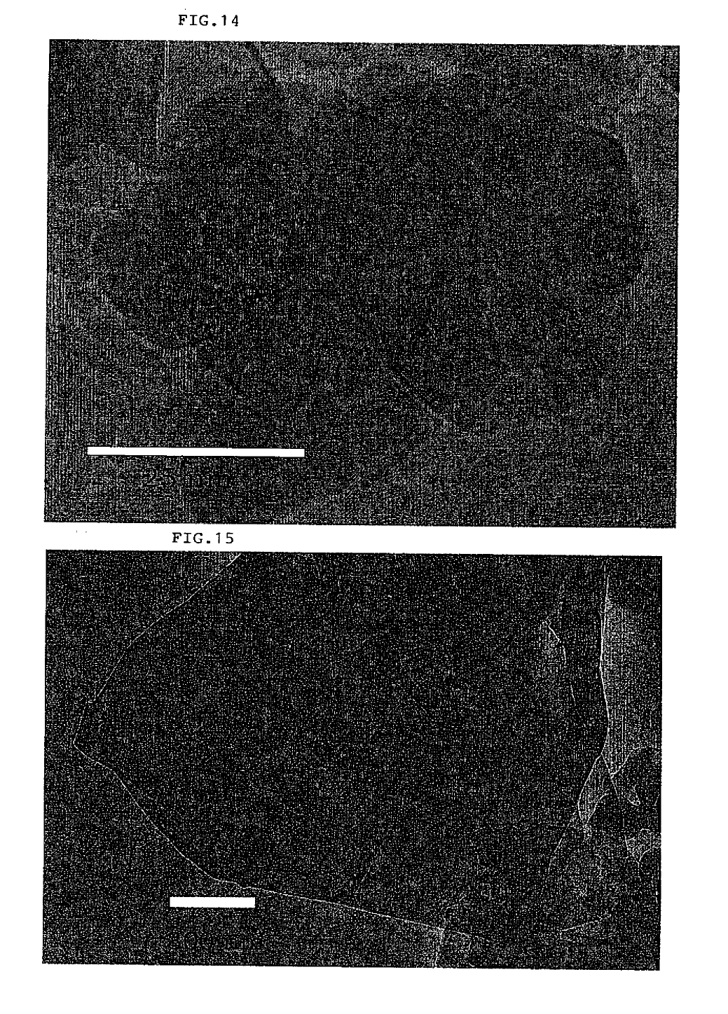

Next, a sample in the case where [TEOS]/[LA]=0.1 after a lapse of 30 minutes since the mixed solution comes into contact with water was cleaned with alcohol to remove the surfactant and was dried at 80° C. A TEM image of the resulting nanosheet is shown in FIG. 14. In FIG. 15, a TEM image of the nanosheet obtained from a sample in the case where [TEOS]/[LA]=0.5 after a lapse of 30 minutes is shown. As is seen in FIG. 14, a SiO₂ nanosheet of several tens of nanometers in diameter was formed in the range of a low TEOS concentration, and as is seen in FIG. 15, a SiO₂ nanosheet of several microns in diameter was formed in the range of a intermediate TEOS concentration. Since both SiO₂ nanosheets are transparent, their thicknesses are estimated to be about several angstroms (A).

Further, in the range of a high concentration in the cases where [TEOS]/[LA]=1 and 4, a broad peak considered to be different from the lamella molecular film was observed in the SAXS pattern even after a lapse of 10 minutes.

### INDUSTRIAL APPLICABILITY

In accordance with the present invention, since a variety of metal oxide nanosheets can be obtained at low cost under mild conditions and in a short time, they can be suitably used in a wide range of areas such as sensor materials, battery materials, various catalysts, and composites with an organic material.

1. A composite nanosheet comprising:
a molecular film consisting of a surfactant and having a lamella structure; and
a metal oxide nanosheet formed along the surface of the molecular film.

2. The composite nanosheet according to claim 1, wherein the total thickness of the molecular film and the metal oxide nanosheet is 5 nm or less.

3. The composite nanosheet according to claim 1, wherein the metal oxide nanosheet is a germanium dioxide nanosheet forming a nearly square having a side of 1000 nm or less.

4. A method of producing the composite nanosheet according to claim 1, the method comprises:
bringing a mixed solution containing a surfactant and a metal alkoxide into contact with water.

5. The method according to claim 4, wherein the contact is made by flowing the mixed solution over the surface of water.

6. The method according to claim 4, wherein the surfactant is a cationic surfactant.

7. The method according to claim 4, wherein the mixed solution contains laurylamine as the surfactant and Ge(OR)₄ in which R is an alkyl group having 1 to 4 carbon atoms as the metal alkoxide, and has a molar concentration ratio [Ge(OR)₄]/[laurylamine] of 0.01 to 0.5.

8. The method according to claim 4, wherein the mixed solution contains laurylamine as the surfactant and is Si(OR)₄ in which R is an alkyl group having 1 to 4 carbon atoms as the metal alkoxide, and has a molar concentration ratio [Si(OR)₄]/[laurylamine] of 0.01 to 0.5.

9. A method of producing a metal oxide nanosheet, the method comprises:
providing the composite nanosheet produced by the method according to claim 4; and separating the metal oxide nanosheet from the molecular film by immersing the composite nanosheet in a solvent in which the surfactant can be dissolved.
